(19) United States
(12) Patent Application Publication
(10) Pub. No.: US 2011/0094198 A1
(43) Pub. Date: Apr. 28, 2011

(54) Fixed frame HVAC adjustment rack for standard sized filters

(76) Inventor: Rick Pindell, Palm Coast, FL (US)

(21) Appl. No.: 12/604,331

(22) Filed: Oct. 22, 2009

(51) Int. Cl. B01D 35/30

(52) U.S. Cl. 55/504

(57) ABSTRACT

A fixed air filter rack apparatus for non-standard sized HVAC units is disclosed. The main embodiment of the fixed filter rack apparatus consists of two piece construction and is made to fit standard sized commercially available filters. The fixed rack apparatus is inserted into the filter slot of the air handler and permanently attached via a single screw or bolt. The standard sized filter is then inserted into the filter rack apparatus such that it makes a seal between the filter and the frame.

### FIELD OF INVENTION

This invention relates generally to a fixed standard sized filter adjustment rack for use in forced heating and cooling systems.

### DISCUSSION

Modern residential heating, ventilation, and air conditioning (HVAC) systems recycle air by use of a blower to pass air through a filter and then redirect it to various locations within a room. Typical filters employee media of various types to effectively remove particulate matter (and smoke) from the air stream thereby cleaning it before returning it to the room. HVAC units however, being designed and used by a multitude of manufactures have varying dimensions and require very specific filter sizes to effect particulate removal. As such the use of an air filter not specifically designed and having the proper dimensions for that particular HVAC unit will decrease the efficiency of the unit as a whole.

This deficiency is accomplished in one of two ways. In the case where a filter is used that is too large, the filter itself will not fit into the filter slot. In cases where the filter is smaller than that of the HVAC unit the filter will not create a seal with the walls of the filter rack causing air to be forced around the sides of the filter rather than through it. This defeats the purpose of having a filter entirely as the flow of air will take the path of least resistance. Most commercially available filters are of a standard size making them either too large or too small to fit most HVAC units. This makes it difficult for a typical consumer to acquire the proper sized filter to match their particular HVAC unit.

One solution is to use an adjustable filter frame that adjusts its dimensions to fit both the HVAC unit and a standard sized filter. This technology employees the use of springs to adjust either the interior frame dimension, the exterior frame dimension, or both. Another solution consists of a removable adjustable filter frame that contains a filter media where both the filter media and the frame itself must be cut to match the HVAC filter slot dimensions. Yet another solution is to forgo the filter slot entirely and mount the filter and filter rack to the exterior of the air handler.

Several drawbacks to this technology exist, first these types of devices tend to be overly complicated and heavy making maintenance difficult. Secondly, the frame and filter media must be permanently modified to fit existing air handlers each time the filter media needs replacement. Thirdly, these devices, due to their complexity, tend to be expensive. Lastly, these devices are not fixed to the HVAC unit but adjustable allowing for the improper fitting to the air handler and possible misdirection of air flow. As such there is a need for a simple, low cost, permanently fixed frame to adapt existing non-standard air handlers to fit specific commercially available standard filter sizes. Therefore it is the object of this invention to solve one or more of these problems.

### SUMMARY OF INVENTION

In accordance with the teachings of the present invention as embodied and described herein, an improved HVAC fixed filter rack is disclosed. The present invention presents a fixed filter rack for commercially available HVAC air filters of standard size to fit nonstandard HVAC units. In one embodiment a fixed HVAC filter rack incorporates a two piece frame capable of permanent attachment to existing HVAC units of non-standard dimensions. In an alternative embodiment the fixed HVAC filter rack may be constructed as a single piece. In both embodiments the fixed filter rack may be constructed from a number of suitable materials.

A number of benefits can be derived through the use of a fixed HVAC filter rack. First, non-standard HVAC units can be made to fit standard sized filters commercially available to consumers. Second the filter rack requires very little modification to existing HVAC units. Lastly the device is simple in its construction, lightweight, and relatively inexpensive compared to the current market technologies.

### BRIEF DESCRIPTION OF DRAWINGS

FIG. 1 is a front perspective view of the filter rack apparatus illustrating the construction and eliminating the filter element.

FIG. 2 is a rear perspective view of the filter rack apparatus illustrating the construction and eliminating the filter element.

FIG. 3 is a front perspective view of an alternative embodiment of the filter rack apparatus illustrating the one piece construction and eliminating the filter element

FIG. 4 is a cross sectional view illustrating the attachment point and screw

FIG. 5 is a perspective view of the orientation of the filter and rack into the filter slot of the air handler.

### DETAILED DESCRIPTION OF DRAWINGS

Referring now to the drawings, and more particularly FIGS. 1 & 2, a fixed filter rack apparatus 6a for non-standard sized HVAC units in accordance with the principles of the present invention is shown. The embodiment depicted in FIG. 1 illustrates apparatus 6a being constructed of two pieces. However, one of ordinary skill in the art would certainly recognize that various other forms may also be utilized. As such the apparatus 6a may be constructed of one or more pieces. The first piece includes a front bottom lock plate 8 and a portion defining a hole 7 for securing the rack 6a to the air handler 24. The second piece includes a left side member 9, left top member 10, left bottom member 15, rear side member 12, rear top member 11, rear bottom member 16, right side member 13, right top member 14, right bottom member 17, and portions defining holes 18 for attaching said first and second pieces together. Said portions defining holes 18 may include one or more points of attachment and may be attached by, without limitation, adhesive, adhesive tape, mechanical clips, physical weld, rivets, bolts, screws, or the like. The filter rack apparatus 6a is oriented such that air flows into the downstream return side 20 from the return duct and through to the upstream supply side 19.

The apparatus 6a has an open front face and a closed rear face. The closed rear face is enclosed by the rear side 12 member, rear bottom member 16, and rear top member 11. The open face is made to receive the filter. The left side member 9, left bottom member 15, and left top member 10, as well as the right (side 13, bottom 17, and top 14 members) form one or more channels to guide the filter during installation.

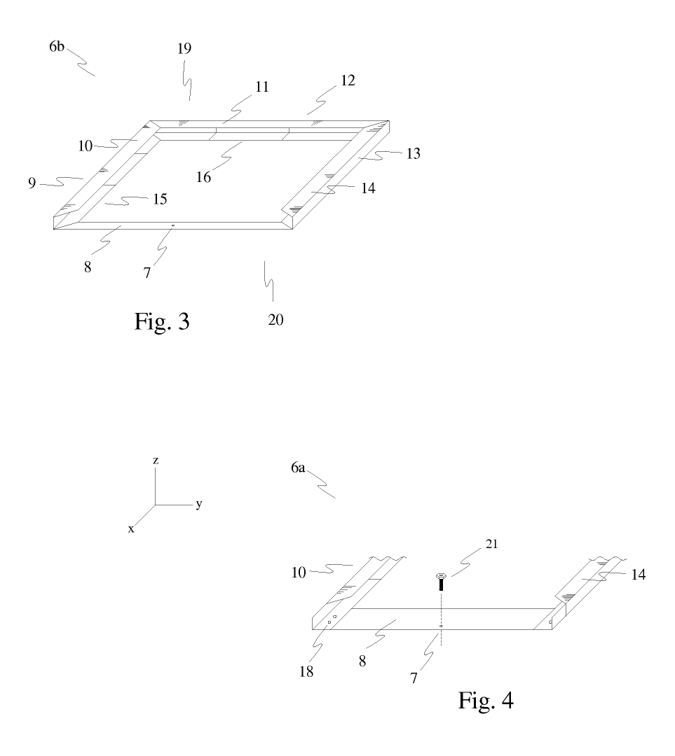

An alternative embodiment of the present invention is illustrated in FIG. 3. As can be seen from FIG. 3 this embodiment of the fixed filter rack apparatus 6b is quite similar to that shown in FIGS. 1 & 2, however in this embodiment the apparatus 6b is constructed from a single piece. This serves to simplify construction for certain materials such as plastics in the case of injection molding.

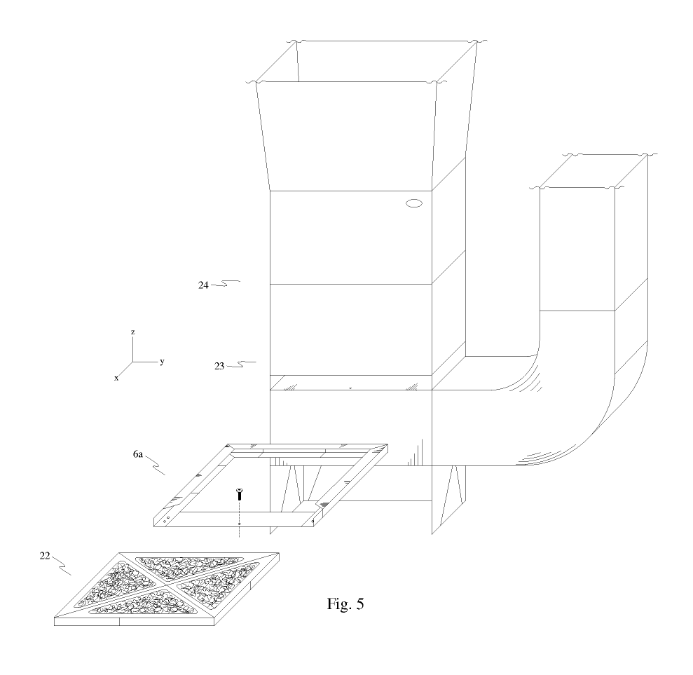

FIG. 4 shows a cross sectional view of the filter rack apparatus 6a highlighting the attaching means 21 passing through the portion defining a hole 7 on the front bottom lock plate 8. As shown in FIG. 5, the filter rack 6a is generally inserted into the receiving filter slot 23 of the air handler unit 24 and secured in place by attaching means 21 (FIG. 4). Whereas the attaching means 21 may include without limitation adhesive, adhesive tape, mechanical clips, rivets, magnets, bolts, screws, or the like. A filter of standard size and various media types may then be inserted into the filter fame apparatus 6a.

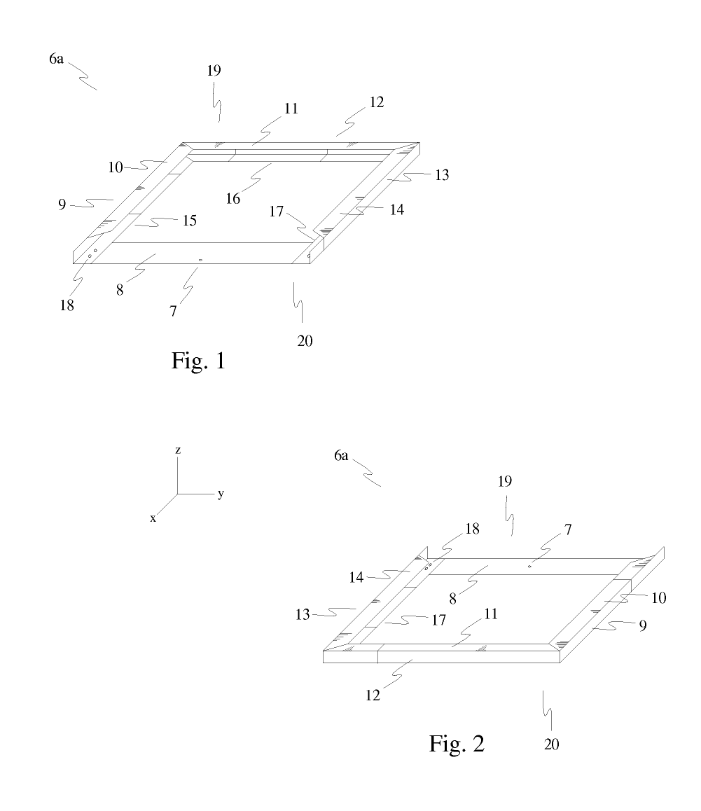

In the various embodiments of the present invention the novel concept is the use of a fixed filter rack 6a & 6b for HVAC units to accommodate standard sized commercially available filters. The fixed filter rack apparatus 6a & 6b illustrated in FIGS. 1-5 is easily manufactured and used. Further the preferred embodiment of apparatus 6a & 6b are designed for “Carrier” HVAC systems but may be used with any type of forced heating and ventilation air conditioning system. The apparatus 6a & 6b may be constructed, pressed, assembled, formed, machined, extruded, molded, woven, blown, punched, cast, or otherwise constructed in any size, shape, or color, and of any suitable material. The suitable material may include without limitation metal, synthetic, polymeric, spun fiberglass, ceramic, cardboard, bio-degradable compounds, or any variation thereof.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

The invention claimed is:

1. A fixed filter rack apparatus to accommodate standard commercially available filters in HVAC units, comprising:
a frame being formed from two pieces, a first piece and a second piece;
said first piece having a left side, top, and bottom member, a right side, top, and bottom member, and a rear side, top, and bottom member, each wall being generally angular in cross section;
said second piece having a lock plate forming a front bottom member;
an attaching means for securing the apparatus to an HAVC unit.

2. The apparatus of claim 1, wherein said left top, right top, and rear top members forming an upstream portion and said left bottom, right bottom, and rear bottom members forming a downstream portion.

3. The apparatus of claim 1, wherein said lock plate forming a front bottom member contains portions defining one or more holes distally disposed to accommodate attaching means for securing said first piece to said second piece.

4. The apparatus of claim 1, wherein said right side, top, and bottom members and left side, top, and bottom members are substantially parallel.

5. The apparatus of claim 1, wherein said right side, top, and bottom members and left side, top, and bottom members each form a channel adapted to receive a standard sized commercially available filter.

6. The apparatus of claim 1, wherein said lock plate forming a front bottom member further contains portions defining a hole, proximally disposed to accommodate attaching means for securing the apparatus to an HVAC unit.

7. A fixed filter rack apparatus to accommodate standard commercially available filters in HVAC units, comprising:
a frame being formed from two pieces, a first piece and a second piece;
said first piece having a left side, top, and bottom member, a right side, top, and bottom member, and a rear side, top, and bottom member, forming a rectangle where each wall being generally angular in cross section;
said second piece having a lock plate forming a front bottom member;
said left top, right top, and rear top members forming an upstream portion;
said left bottom, right bottom, and rear bottom members forming a downstream portion;
said right side, top, and bottom members and left side, top, and bottom members are substantially parallel;
an attaching means for securing the apparatus to an HAVC unit.

8. The apparatus of claim 1, wherein said lock plate forming a front bottom member contains portions defining one or more holes distally disposed to accommodate attaching means for securing said first piece to said second piece.

9. The apparatus of claim 1, wherein said right side, top, and bottom members and left side, top, and bottom members each form a channel adapted to receive a standard sized commercially available filter.

10. The apparatus of claim 1, wherein said lock plate forming a front bottom member further contains portions defining a hole, proximally disposed to accommodate attaching means for securing the apparatus to an HVAC unit.
